(19) United States
(12) Patent Application Publication
(10) Pub. No.: US 2006/0230886 A1
(43) Pub. Date: Oct. 19, 2006

(54) Pliers having pivotal handles

(76) Inventor: Chih-Ching Hsien, Taichung City (TW)

Correspondence Address: PHILLIP LIU, 6980, WHITEOAK DR., RICHMOND, BC, V7EAZ9, CA

(21) Appl. No.: 11/452,349

(22) Filed: Jun. 14, 2006

Related U.S. Application Data
(63) Continuation-in-part of application No. 10/910,287, filed on Aug. 4, 2004.

(51) Int. Cl. B25B 23/16; B25B 7/02

(52) U.S. Cl. 81/424; 81/427; 81/418; 81/177.9

(57) ABSTRACT

A pair of pliers includes two jaws pivotably connected with each other and each jaw has a connection neck including two lugs. Two grips each have a protrusion extending from an end thereof and the protrusion is pivotably between the two lugs of respective one of the two connection necks. Two shafts respectively extend through the lugs of the two connection necks and the protrusions between the lugs. A positioning device is connected between the protrusion and the connection neck so as to position the grip relative to the connection neck.

### FIELD OF THE INVENTION

This is a Continuation-In-Part applicant of applicant's former application with application Ser. No. 10/910,287, filed Aug. 4, 2004.

### BACKGROUND OF THE INVENTION

A conventional pair of pliers generally includes two jaws and two grips which are connected to the two jaws which are pivotably connected with each other. The user has to bend his or her wrist to open or close the grips top operate the pliers. It is noted that the pliers and the grips are located in the same plane so that the user is easily to be suffered by carpal tunnel syndrome. U.S. Pat. No. 6,370,992 discloses that the two grips are pivotably connected to the two jaws. However, each jaw has a neck section and each grip has a protrusion which is pivotably connected to the neck section. Although the jaws can be pivoted an angle relative to the grips, the connection between the jaw and the handle is too weak to bear a large torque. In other words, the neck portion or the protrusion could be bent or damaged when a large torque is applied thereto.

The present invention intends to provide a pair of pliers wherein each of the grips has a protrusion which is pivotably connected between two lugs of one of the two jaws.

### SUMMARY OF THE INVENTION

The present invention relates to a pair of pliers which comprises two jaws pivotably connected with each other and each jaw has a connection neck which includes two lugs. Two grips each have a protrusion extending from an end thereof and the protrusion is pivotably between the two lugs of respective one of the two connection necks by extending a shaft.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the pliers of the present invention;

FIG. 2 is a perspective view to show the pliers of the present invention;

FIG. 3 is a cross sectional view to show the connection of the connection necks of the jaws and the protrusion of the grips;

FIG. 4 is a side cross sectional view to show the positioning device for positioning the grips of the pliers of the present invention;

FIG. 5 is a side cross sectional view to show the jaws are pivoted relative to the grips of the pliers of the present invention, and

FIG. 6 is a perspective view to show that the jaws are pivoted 90 degrees relative to the grips.

### DETAILED DESCRIPTION OF THE PREFERRED EMBODIMENT

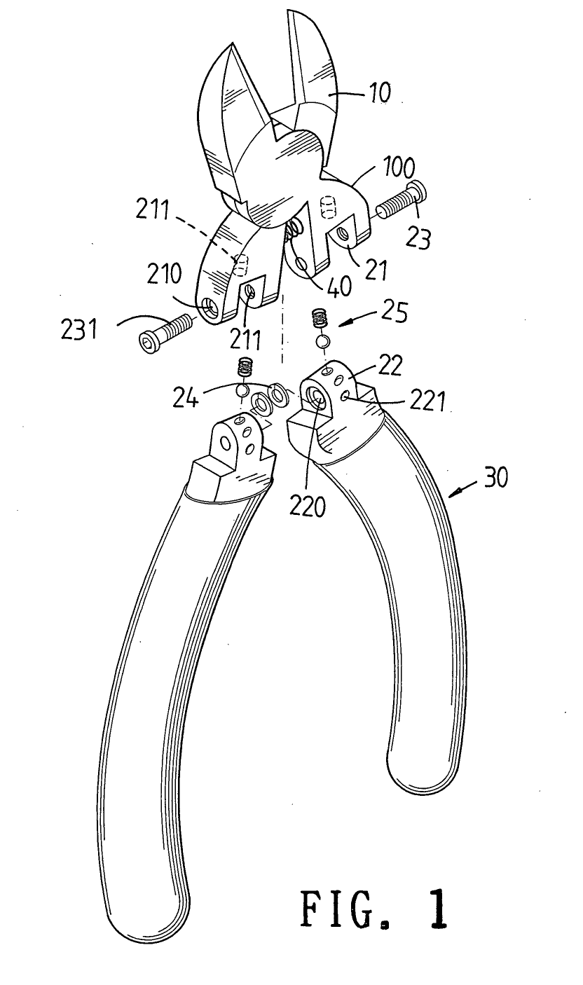

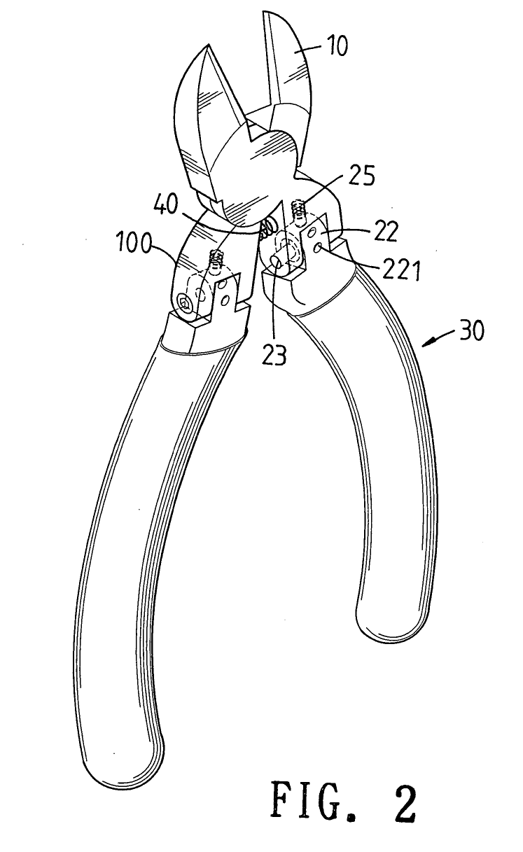

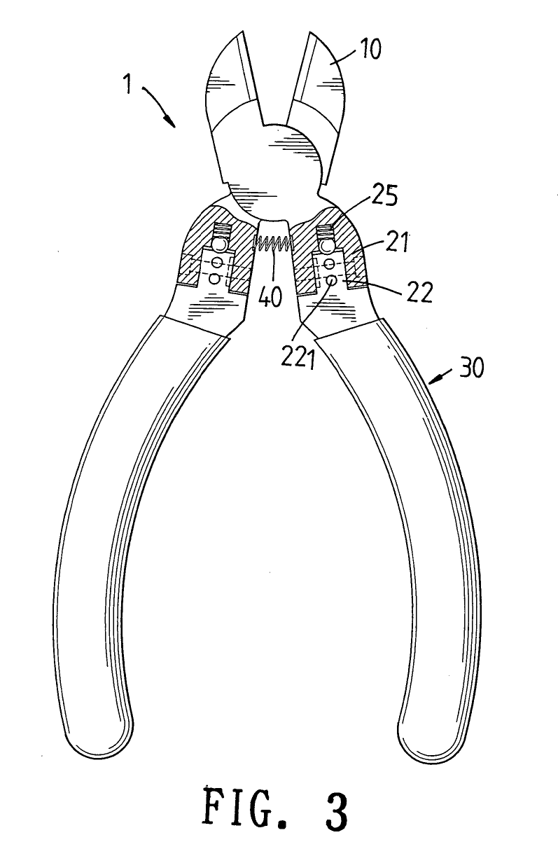

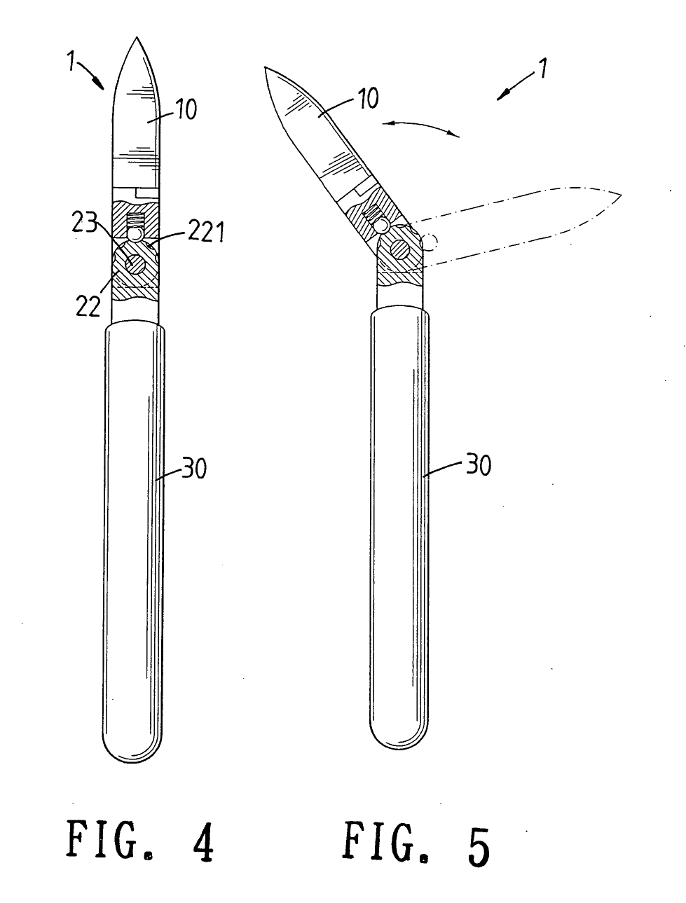

Referring to FIGS. 1 to 4, the pliers 1 of the present invention comprise two parts and each part includes a jaw 10 on a first end thereof and a connection neck 100 is connected to a second end of each part. The two parts are pivotably connected with each other at a mediate portion thereof. Each connection neck 100 includes two lugs 21 extending therefrom so as to define a space between the two lugs 21. The two lugs 21 each extend toward a direction opposite to a longitudinal axis of the jaw 10. One of the two lugs 21 of each connection neck 100 has a through hole 210 and the other lug has a threaded hole 211. A spring 40 is connected between the two connection necks 100 so as to maintain an open status of the two connection necks 100. A recess 211 is defined in a distal end of each connection neck 100 and communicates with the space. A positioning device 25 including a spring and a bead is received in each of the recesses 211, wherein the bead is partially retained in the recess 211.

Two grips 30 each have a protrusion 22 extending from an end thereof and the protrusion 22 has a passage 220 defined through the protrusion 22. Each protrusion 22 further has a plurality of dents 221 defined in an outer periphery thereof. The protrusion 22 is pivotably between the two lugs 21 of respective one of the two connection necks 100 and two shafts 23 respectively extend through the lugs of the two connection necks 100, a washer 24 and a passage 220 defined through the protrusions 22 between the lugs 21. Each shaft 23 has a threaded section 231 which is threadedly connected to the threaded hole 211. The bead is engaged with one of the dents 221 to position the grip 30 relative to the connection neck 100.

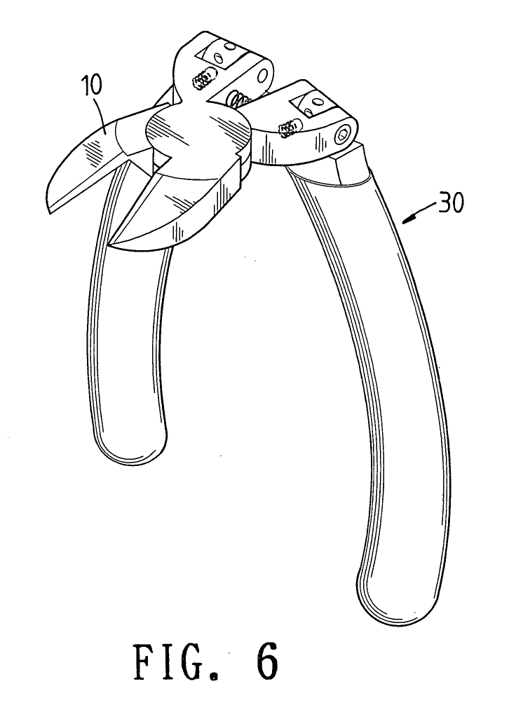

As shown in FIGS. 5 and 6, the connection necks 100 can be pivoted relative to the protrusions 22 when needed, and the engagement between the bead and the dents 221 effectively positions the grip 30 in desired position. It is noted that each protrusion 22 is connected between two lugs 100 and is capable of bearing a large torque so as to improve the shortcoming of conventional pliers.

While we have shown and described the embodiment in accordance with the present invention, it should be clear to those skilled in the art that further embodiments may be made without departing from the scope of the present invention.

What is claimed is:

1. A pair of pliers comprising:
two parts and each part including a jaw on a first end thereof and a connection neck connected to a second end of each part, the two parts being pivotably connected with each other at a mediate portion thereof, Each connection neck including two lugs extending therefrom so as to define a space between the two lugs, the two lugs each extending toward a direction opposite to a longitudinal axis of the jaw, a recess defined in a distal end of each connection neck and communicating with the space, a spring and a bead received in each of the recesses, a second spring connected between the two connection necks;
two grips each having a protrusion extending from an end thereof and the protrusion pivotably between the two lugs of respective one of the two connection necks, each protrusion having a plurality of dents defined in an outer periphery thereof and the bead being engaged with one of the dents, and
two shafts respectively extending through the lugs of the two connection necks and the protrusions between the lugs.

2. The pliers as claimed in claim 1, wherein one of the two lugs of each connection neck has a through hole and the other lug has a threaded hole, each shaft has a threaded section which is threadedly connected to the threaded hole.
